(19) United States
(12) Patent Application Publication
(10) Pub. No.: US 2008/0170617 A1
(43) Pub. Date: Jul. 17, 2008

(54) APPARATUS FOR AND METHOD OF ESTIMATING MOTION VECTOR

(75) Inventors: Seung-hoon Han, Seoul (KR); Dae-hyun Kim, Suwon-si (KR); Seung-joon Yang, Seoul (KR); Young-ho Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/742,632

(22) Filed: May 1, 2007

(30) Foreign Application Priority Data
Jan. 12, 2007 (KR) 10-2007-0003977

(51) Int. Cl. H04B 1/66

(52) U.S. Cl. 375/240.16; 375/E07.092

(57) ABSTRACT

An apparatus for and method of estimating a motion vector for a video image block are provided. The apparatus includes an error calculation unit calculating a motion estimation error for a predetermined prediction motion vector of the image block, an information extraction unit extracting geometric information regarding the image block, an update motion vector generation unit generating an update motion vector based on the motion estimation error calculated by the error calculation unit and the geometric information extracted by the information extraction unit, and an addition unit adding the prediction motion vector to the generated update motion vector.

### CROSS-REFERENCE TO RELATED PATENT APPLICATION

This application claims priority from Korean Patent Application No. 10-2007-0003977, filed on Jan. 12, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to estimating a motion vector.

2. Description of the Related Art

Motion estimation between image blocks in a video sequence has become more popular in a variety of applications, especially in digital signal processing of present TV receivers. In image processing such as Frame Rate up-Conversion (FRC), Interaced to Progressive Conversion (IPC), and the like, motion estimation between image frames is essentially performed. Motion estimation involves estimating a motion vector for motion compensation and is a core technique for improving display quality in various video processing systems. Generally, motion estimation is performed using a block matching algorithm. The block matching algorithm compares two consecutively input frames (or fields) block-by-block to estimate a motion vector per block. At this time, the motion vector is estimated using a motion estimation error, e.g., a Sum of Absolute Difference (SAD), and motion compensation is performed using the estimated motion vector.

FIG. 1 is a block diagram of a related art motion vector estimation apparatus.

Referring to FIG. 1, a signal f_{BL} generated for an image block is input to a counter 1 and an output of the counter 1 is input to a comparator 2 and a memory 3. The memory 3 stores a plurality of update vectors (a horizontal component Ux and a vertical component Uy). The update vectors stored in the memory 3 are fixed and can be selected in a desired order. The update vector selected from the memory 3 is input to adders 4 and 5 to be added to prediction vector components (a horizontal component Px and a vertical component Py). By adding the prediction vector to the selected update vector, new vector components (Nx, Ny) are generated, which constitute a final estimated motion vector. The motion vector estimation apparatus repeats adding the prediction vector to the update vector selected from the stored update vectors until a difference between the luminance of a prediction block and the luminance of the current block becomes smallest.

FIG. 2 is a reference diagram showing the size of a motion estimation error caused by the related art motion vector estimation apparatus, in which a graph of an SAD with respect to a frame is shown. As can be seen from FIG. 2, an SAD appears to converge but increases again. Since the update vectors are fixed to several values in the related art motion vector estimation apparatus, it is difficult to accurately estimate motion and the probability of error occurring increases. Moreover, since the update vectors that are fixed irrespective of the characteristics of motion are generated, the convergence speed (SAD) is low and the convergence (SAD) may not occur at all in a moving picture with fast motion.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus for and a method of estimating a motion vector in order to accurately estimate the motion of a moving picture.

The present invention also provides an apparatus for and a method of estimating a motion vector in order to maximize a motion estimation error and increase the convergence speed of the motion estimation error for a moving picture with fast motion.

According to one aspect of the present invention, there is provided an apparatus for estimating a motion vector for a video image block. The apparatus includes an error calculation unit that calculates a motion estimation error for a predetermined prediction motion vector of the image block, an information extraction unit that extracts geometric information regarding the image block, an update motion vector generation unit that generates an update motion vector based on the motion estimation error calculated by the error calculation unit and the geometric information extracted by the information extraction unit, and an addition unit that adds the prediction motion vector to the generated update motion vector.

The error calculation unit may calculate a Sum of Absolute Differences (SAD) for the predetermined prediction motion vector and the update motion vector generation unit may generate the update motion vector based on the calculated SAD.

The size of the update motion vector generated by the update motion vector generation unit may be proportional to the calculated SAD.

The geometric information extracted by the information extraction unit may include information about whether the image block is an edge region, a corner region, or a flat region.

The information extraction unit may extract information about the directivity or size of an edge from the image block, and the update motion vector generation unit may generate the update motion vector based on the motion estimation error calculated by the error calculation unit and the directivity or size of the edge extracted by the information extraction unit.

The information extraction unit may extract information about the directivity or size of an edge from the image block, and the update motion vector generation unit may generate the update motion vector based on the SAD calculated by the error calculation unit and the directivity or size of the edge extracted by the information extraction unit.

The directivity or size of the edge may be extracted by Principal Component Analysis (PCA).

According to another aspect of the present invention, there is provided a method of estimating a motion vector for a video image block. The method includes calculating a motion estimation error for a predetermined prediction motion vector of the image block, extracting geometric information regarding the image block, generating an update motion vector based on the calculated motion estimation error and the extracted geometric information, and adding the prediction motion vector to the generated update motion vector.

The calculation of the motion estimation error may include calculating a Sum of Absolute Differences (SAD) for the predetermined prediction motion vector and the generation of the update motion vector may include generating the update motion vector based on the calculated SAD.

The size of the generated update motion vector may be proportional to the calculated SAD.

The extracted geometric information may include information about whether the image block is an edge region, a corner region, or a flat region.

The extraction of the geometric information may include extracting information about the directivity or size of an edge from the image block, and the generation of the update motion vector may include generating the update motion vector based on the calculated motion estimation error and the extracted directivity or size of the edge.

The extraction of the geometric information may include extracting information about the directivity or size of an edge from the image block, and the generation of the update motion vector may include generating the update motion vector based on the calculated SAD and the extracted directivity or size of the edge.

The directivity or size of the edge may be extracted by Principal Component Analysis (PCA).

According to another aspect of the present invention, there is provided a computer-readable recording medium having recorded thereon a program for implementing a method of estimating a motion vector for a video image block. The method includes calculating a motion estimation error for a predetermined prediction motion vector of the image block, extracting geometric information regarding the image block, generating an update motion vector based on the calculated motion estimation error and the extracted geometric information, and adding the prediction motion vector to the generated update motion vector.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a related art motion vector estimation apparatus;

FIG. 2 is a reference diagram of the size of a motion estimation error caused by the related art motion vector estimation apparatus;

FIG. 3 is a block diagram of an apparatus for estimating a motion vector according to a first exemplary embodiment of the present invention;

FIG. 4 is a block diagram of an apparatus for estimating a motion vector according to a second exemplary embodiment of the present invention;

FIG. 5 is a block diagram of an apparatus for estimating a motion vector according to a third exemplary embodiment of the present invention;

FIG. 6 is a reference diagram for explaining an operation of an apparatus for estimating a motion vector according to an exemplary embodiment of the present invention;

FIG. 7 is a reference diagram of the size of a motion estimation error caused by an apparatus for estimating a motion vector according to an exemplary embodiment of the present invention;

FIG. 8 is a flowchart of a method of estimating a motion vector according to a first exemplary of the present invention; and

FIG. 9 is a flowchart of a method of estimating a motion vector according to a second exemplary of the present invention.

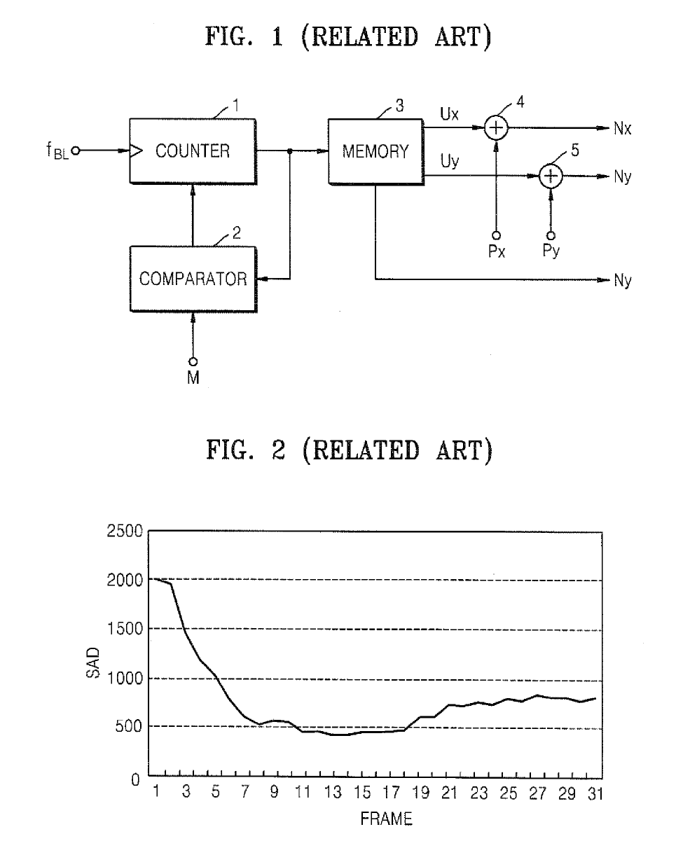

### DETAILED DESCRIPTION OF THE INVENTION

Hereinafter, exemplary embodiments of the present invention will be described in detail with reference to the accompanying drawings. It should be noticed that like reference numerals refer to like elements illustrated in one or more of the drawings. In the following description of the exemplary embodiments of the present invention, a detailed description of known functions and configurations incorporated herein will be omitted for conciseness and clarity.

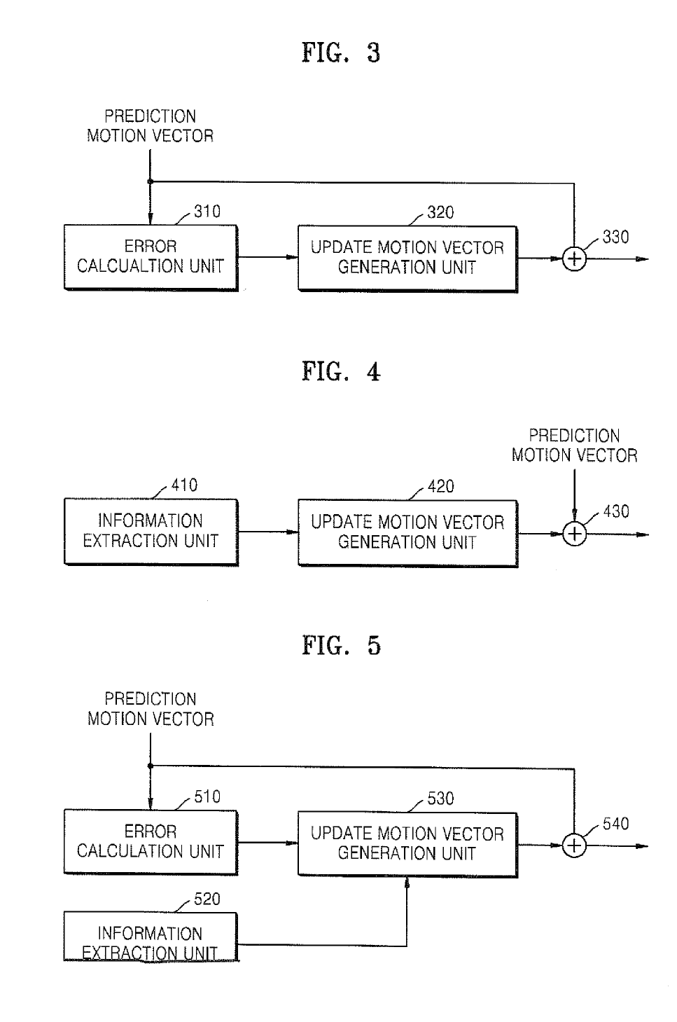

FIG. 3 is a block diagram of an apparatus for estimating a motion vector according to a first exemplary embodiment of the present invention.

Referring to FIG. 3, the apparatus includes an error calculation unit 310, an update motion vector generation unit 320, and an addition unit 330.

A first frame (or field), a second frame (or field), and a prediction motion vector for motion comparison and estimation are input to the error calculation unit 310. The prediction motion vector is a predetermined motion vector around the current pixel or block. The error calculation unit 310 calculates a motion estimation error for the prediction motion vector in blocks of the first frame and the second frame. For example, the error calculation unit 310 calculates a Sum of Absolute Difference (SAD) for the predetermined prediction motion vector. The SAD is an index of an error of the prediction motion vector.

The update motion vector generation unit 320 generates an update motion vector based on the motion estimation error calculated by the error calculation unit 310. The update motion vector generated by the update motion vector generation unit 320 is not fixed but may vary with the calculated motion estimation error. For example, since an SAD for a block with a large amount of motion is large, the convergence speed of the motion estimation error with respect to fast motion can be increased by increasing the size of the update motion vector in proportion to the SAD.

The addition unit 330 adds the predetermined prediction motion vector to the update motion vector generated by the update motion vector generation unit 320, thereby generating a final candidate motion vector.

FIG. 4 is a block diagram of an apparatus for estimating a motion vector according to a second exemplary embodiment of the present invention.

Referring to FIG. 4, the apparatus includes an information extraction unit 410, an update motion vector generation unit 420, and an addition unit 430.

The information extraction unit 410 extracts geometric information regarding an M×N region around the current pixel from a frame. The geometric information includes information about the characteristic of the current region, e.g., information about whether the current region is an edge region, a corner region, or a flat region. The directivity and size of an edge are detected by the information extraction unit 410 in order to reduce reliability with respect to the horizontal motion of the edge in the edge region. This is because the edge's motion during horizontal movement is difficult to recognize and only the edge's motion during vertical movement can be recognized. In a geometric position such as the corner region, motion can be accurately extracted and thus the reliability of an update motion vector would be high. It is called an aperture issue that the reliability of motion estimation varies according to the region. By generating the update motion vector with adaptive coding with the aperture issue, the accuracy of motion estimation can be improved. Geometric information regarding an image block may be extracted by, for example, edge detection or Principal Component Analysis (PCA).

The update motion vector generation unit 420 generates an update motion vector based on the directivity or size of an edge, which is input from the information extraction unit 410. The update motion vector is generated perpendicular to the direction of the edge (or corner). The addition unit 430 adds a predetermined prediction motion vector to the update motion vector generated by the update motion vector generation unit 320, thereby generating a final candidate motion vector.

FIG. 5 is a block diagram of an apparatus for estimating a motion vector according to a third exemplary embodiment of the present invention.

Referring to FIG. 5, the apparatus includes an error calculation unit 510, an information extraction unit 520, an update motion vector generation unit 530, and an addition unit 540.

Two image frames to be motion-estimated are input to the error calculation unit 510. The error calculation unit 510 then calculates a motion estimation error, e.g., an SAD, for a prediction motion vector. The information extraction unit 520 extracts geometric information regarding a region around the current pixel to recognize the directivity or size of an edge.

The update motion vector generation unit 530 generates an update motion vector based on the motion estimation error calculated by the error calculation unit 510 and the geometric information extracted by the information extraction unit 520. When the size of the motion estimation error is large, the size of the update motion vector also has to be large and the update motion vector has to be perpendicular to the direction of an edge or a corner. The addition unit 540 adds a predetermined prediction motion vector to the update motion vector generated by the update motion vector generation unit 530, thereby generating a final candidate motion vector.

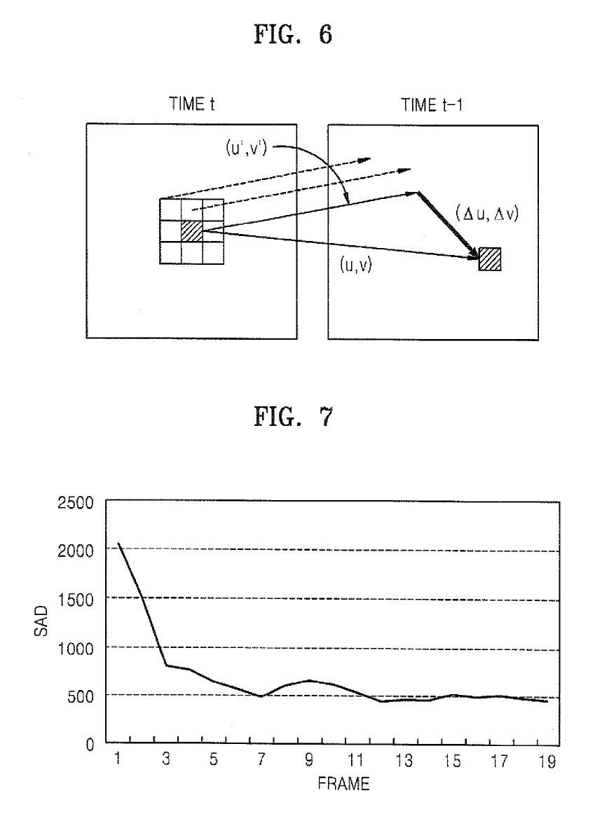

FIG. 6 is a reference diagram for explaining an operation of an apparatus for estimating a motion vector according to the exemplary embodiment of the present invention.

In FIG. 6, a relationship among a prediction motion vector (u′, v′), an update motion vector (∇u, ∇v), and a new candidate motion vector (u, v) generated using them is diagrammed.

As illustrated in FIG. 6, a motion estimation vector can be obtained by adding the prediction motion vector (u′, v′) and the update motion vector (∇u, ∇v) as follows:

(u,v)=(u′,v′)+(∇u,∇v) EQN. (1)

The motion estimation vector means displacement from a block (or pixel) of a frame at current time t to a position having the most similar luminance as the block in a previous frame at time (t−1). Such a relationship can be expressed in terms of Maximum a Posteriori (MAP) estimation, as follows:

$$( {u}^{*} , {v}^{*} ) = \text{arg} min ( E ( u , v ) = {\sum }_{( v , y ) ∈ R} ( I ( x + u , y + v , t + 1 ) - I ( x , y , t ) ) 2 ) \qquad EQN . ( 2 )$$

By applying gradient-based optimization to the optimization Equation (2), the following solution can be obtained:

u=u′−α∇ᵤE(u)|_{u′} EQN. (3),

where u′ indicates a prediction motion vector and α is a constant. Equation (3) can be arranged as follows:

$$u = {u}^{′} - α {∇}_{u} E ( u ) {\vert}_{{u}^{′}} = {u}^{′} - α dfd ( {u}^{′} ) {∇}_{x} I ( x - {u}^{′} , t - 1 ) dfd ( {u}^{′} ) = {\sum }_{x ∈ R} I ( x , t ) - I ( x - {u}^{′} , t - 1 ) \qquad EQN . ( 4 )$$

The update motion vector du depends on a displaced frame difference (dfd) in a region R and a gradient image ∇I(x−u′, t−1) of an input frame (a frame at time t−1). An error between regions, which functions in the same manner as dfd, is calculated by the error calculation unit 310.

FIG. 7 is a reference diagram of the size of a motion estimation error caused by the apparatus for estimating a motion vector according to the exemplary embodiment of the present invention.

FIG. 7 illustrates a graph showing an SAD with respect to a frame. An SAD converges to a predetermined minimum value in FIG. 7 when compared to FIG. 2. In other words, the size of an update motion vector is changed based on a motion estimation error and geometric information, thereby performing more accurate motion estimation.

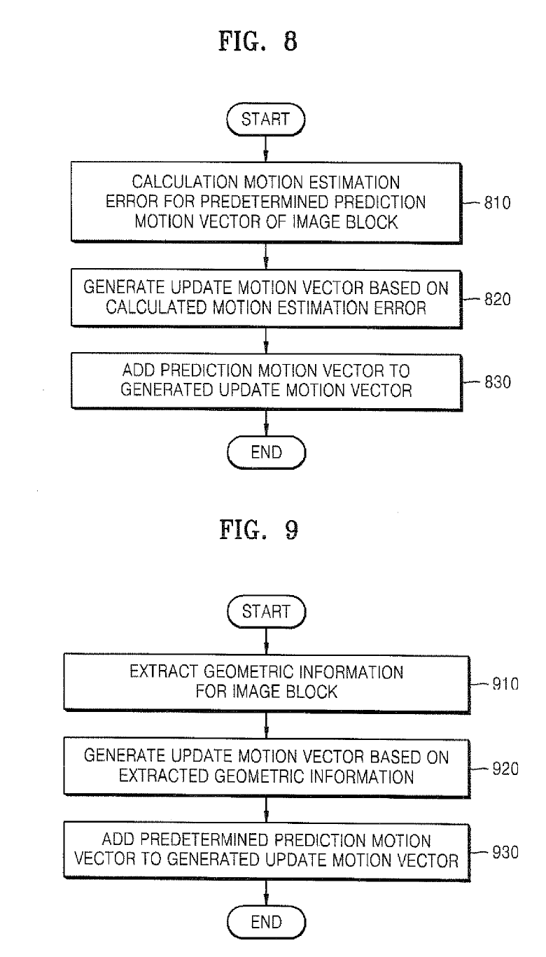

FIG. 8 is a flowchart of a method of estimating a motion vector according to a first exemplary embodiment of the present invention.

Referring to FIG. 8, in operation 810, a motion estimation error for a predetermined prediction motion vector of an image block is calculated. The prediction motion vector is a predetermined motion vector around the current pixel or block. An SAD for the predetermined prediction motion vector is calculated and an update motion vector is generated based on the SAD.

In operation 820, the update motion vector is generated based on the generated motion estimation error. A candidate motion vector is calculated using the update motion vector that is not fixed, but varies with the motion estimation error. For example, since an SAD for a block with a large amount of motion is large, the convergence speed of the motion estimation error with respect to fast motion can be increased by increasing the size of the update motion vector in proportion to the SAD.

In operation 830, the prediction motion vector is added to the update motion vector generated in operation 820, thereby generating a candidate motion vector. Once the candidate motion vector for the current block is determined, the determined candidate motion vector may serve as a prediction motion vector for a neighboring block around the current block. When a candidate motion vector for the neighboring block is determined, operations 810 through 830 are performed for the neighboring block.

FIG. 9 is a flowchart of a method of estimating a motion vector according to a second exemplary embodiment of the present invention.

Referring to FIG. 9, in operation 910, geometric information regarding an image block to be motion-estimated is extracted. The geometric information includes information about the characteristic of the current region, e.g., information about whether the current region is an edge region, a corner region, or a flat region. Since motion during horizontal movement is difficult to recognize and motion only during vertical movement can be recognized in the edge region, reliability with respect to horizontal motion has to be reduced.

In operation 920, an update motion vector is generated based on information extracted in operation 910. Using input information about the directivity of an edge, the update motion vector has to be generated perpendicular to the direction of the edge. In operation 930, a prediction motion vector is added to the update motion vector generated in operation 920, thereby generating a candidate motion vector.

As described above, according to the exemplary embodiment of the present invention, motion of a moving picture can be accurately estimated.

Moreover, it is possible to maximize a motion estimation error and increase the convergence speed of the motion estimation error for a moving picture with fast motion.

Meanwhile, the present invention can also be embodied as a program that can be executed on a computer and can be embodied on a general-purpose digital computer for implementing the program using a computer-readable code.

The computer-readable recording medium is any data storage device that can store data which can be thereafter read by a computer system. Examples of computer-readable recording media include read-only memory (ROM), random-access memory (RAM), CD-ROMs, magnetic tapes, floppy disks, and optical data storage devices. The computer-readable recording medium can also be distributed over a network of coupled computer systems so that the computer-readable code is stored and executed in a decentralized fashion.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. An apparatus for estimating a motion vector for an image block, the apparatus comprising:
an error calculation unit which calculates a motion estimation error for a predetermined prediction motion vector of the image block;
an information extraction unit which extracts geometric information regarding the image block;
an update motion vector generation unit which generates an update motion vector based on the motion estimation error calculated by the error calculation unit and the geometric information extracted by the information extraction unit; and
an addition unit which adds the predetermined prediction motion vector to the generated update motion vector.

2. The apparatus of claim 1, wherein the error calculation unit calculates a Sum of Absolute Differences (SAD) for the predetermined prediction motion vector and the update motion vector generation unit generates the update motion vector based on the calculated SAD.

3. The apparatus of claim 2, wherein a size of the update motion vector generated by the update motion vector generation unit is proportional to the calculated SAD.

4. The apparatus of claim 1, wherein the geometric information extracted by the information extraction unit includes information about whether the image block is an edge region, a corner region, or a flat region.

5. The apparatus of claim 1, wherein the information extraction unit extracts information about a directivity or a size of an edge from the image block, and the update motion vector generation unit generates the update motion vector based on the motion estimation error calculated by the error calculation unit and the directivity or the size of the edge extracted by the information extraction unit.

6. The apparatus of claim 2, wherein the information extraction unit extracts information about a directivity or a size of an edge from the image block, and the update motion vector generation unit generates the update motion vector based on the SAD calculated by the error calculation unit and the directivity or the size of the edge extracted by the information extraction unit.

7. The apparatus of claim 6, wherein the directivity or the size of the edge is extracted by Principal Component Analysis (PCA).

8. A method of estimating a motion vector for an image block, the method comprising:
calculating a motion estimation error for a predetermined prediction motion vector of the image block;
extracting geometric information regarding the image block;
generating an update motion vector based on the calculated motion estimation error and the extracted geometric information; and
adding the predetermined prediction motion vector to the generated update motion vector.

9. The method of claim 8, wherein the calculating of the motion estimation error comprises calculating a Sum of Absolute Differences (SAD) for the predetermined prediction motion vector and the generating of the update motion vector comprises generating the update motion vector based on the calculated SAD.

10. The method of claim 9, wherein a size of the generated update motion vector is proportional to the calculated SAD.

11. The method of claim 8, wherein the extracted geometric information includes information about whether the image block is an edge region, a corner region, or a flat region.

12. The method of claim 8, wherein the extracting of the geometric information comprises extracting information about a directivity or a size of an edge from the image block, and the generating of the update motion vector comprises generating the update motion vector based on the calculated motion estimation error and the extracted directivity or the size of the edge.

13. The method of claim 9, wherein the extracting of the geometric information comprises extracting information about a directivity or a size of an edge from the image block, and the generating of the update motion vector comprises generating the update motion vector based on the calculated SAD and the extracted directivity or the size of the edge.

14. The method of claim 12, wherein the directivity or size of the edge is extracted by Principal Component Analysis (PCA).

15. A computer-readable recording medium having recorded thereon a program for implementing a method of estimating a motion vector for an image block, the method comprising:
calculating a motion estimation error for a predetermined prediction motion vector of the image block;
extracting geometric information regarding the image block;
generating an update motion vector based on the calculated motion estimation error and the extracted geometric information; and
adding the predetermined prediction motion vector to the generated update motion vector.
